(19) United States
(12) Patent Application Publication
(10) Pub. No.: US 2025/0203154 A1
(43) Pub. Date: Jun. 19, 2025

(54) AUDIO AND VIDEO SYNCHRONIZATION DETECTION METHOD, DEVICE, ELECTRONIC EQUIPMENT AND TERMINAL

(71) Applicant: BEIJING BAIDU NETCOM SCIENCE TECHNOLOGY CO., LTD., Beijing (CN)

(72) Inventor: Xiangyang Wang, Beijing (CN)

(73) Assignee: BEIJING BAIDU NETCOM SCIENCE TECHNOLOGY CO., LTD., Beijing (CN)

(21) Appl. No.: 18/991,074

(22) Filed: Dec. 20, 2024

(30) Foreign Application Priority Data
Sep. 10, 2024 (CN) 202411262508.9

(51) Int. Cl. H04N 21/439; G06T 7/246; G06V 40/16; H04N 21/43

(52) U.S. Cl. CPC H04N 21/4394; G06T 7/246; G06V 40/161; G06V 40/171; H04N 21/43072; G06T 2207/30201

(57) ABSTRACT

The disclosure provides an audio and video synchronization detection method, an audio and video synchronization detection device, an electronic equipment and a terminal, and relates to a field of image processing, in particular to the technical fields of computer vision, artificial intelligence and the like. The method includes: extracting image data and audio data of a video segment of a target length; obtaining a plurality of face image lists by performing face detection and tracking based on the extracted image data; extracting mouth features corresponding to each face image list based on a traversal result of the face image list, in which the mouth features are used for representing changes in lip shape; and determining a synchronization result of the video segment based on the audio data and the mouth features.

### CROSS REFERENCE TO RELATED APPLICATIONS

This application claims priority and benefits to Chinese Application No. 2024112625089, filed on Sep. 10, 2024, the entire content of which is incorporated herein by reference.

### TECHNICAL FIELD

The disclosure relates to the technical field of image processing, specifically to the technical fields of computer vision and artificial intelligence, and in particular to an audio and video synchronization detection method, device, an electronic equipment and a terminal.

### BACKGROUND

During the processes of video editing, encoding and playback, there may be instances where the lip movements in the video do not match the audio, adversely affecting the user's viewing experience. In the related art, reference-based methods are often used for audio and video synchronization detection, for example adding tags or comparing with a reference video. Alternatively, non-reference methods can also be used for audio and video synchronization detection, for example detecting based on the opening and closing of the mouth or the presence of speech information. However, the above methods cannot be applied to practical scenarios, and frequently result in false detections, necessitating manual secondary verification, which consumes considerable manpower and time. Therefore, improving the accuracy and reliability of audio and video synchronization detection has become an urgent issue to be addressed.

### SUMMARY

The disclosure provides an audio and video synchronization detection method, device, an electronic equipment, a terminal and a computer program product.

Based on a first aspect of embodiments of the disclosure, an audio and video synchronization detection method is proposed. The method includes: extracting image data and audio data of a target-length video segment; obtaining a plurality of face image lists by performing face detection and tracking based on the extracted image data; extracting mouth features corresponding to each face image list based on a traversal result of each face image list, in which the mouth features are used for characterize changes in lip movements; and determining a synchronization result of the video segment based on the audio data and the mouth features.

Based on a second aspect of embodiments of the disclosure, an electronic equipment is proposed. The electronic equipment includes: at least one processor and a memory communicatively connected to the at least one processor. The memory stores instructions executable by the at least one processor, and when the instructions are executed by the at least one processor, the at least one processor is caused to execute the audio and video synchronization detection method proposed in the first aspect.

Based on a third aspect of embodiments of the disclosure, a terminal is proposed. The terminal includes the electronic equipment proposed in the embodiment of the third aspect.

Based on a fourth aspect of embodiments of the disclosure, a computer program product including a computer program is proposed. When the computer program is executed by a processor, the audio and video synchronization detection method proposed in the first aspect is executed.

It should be understood that what is described in this section is not intended to identify key or important features of the embodiments of the disclosure, nor is it intended to limit the scope of the disclosure. Other features of the disclosure will be readily understood from the following description.

### BRIEF DESCRIPTION OF THE DRAWINGS

The attached drawings are for better understanding this scheme and do not constitute a limitation of this disclosure, in which:

FIG. 1 is a flowchart of an audio and video synchronization detection method based on an embodiment of the disclosure.

FIG. 2 is a flowchart of an audio and video synchronization detection method based on an embodiment of the disclosure.

FIG. 3 is a flowchart of an audio and video synchronization detection method based on an embodiment of the disclosure.

FIG. 4 is a flowchart of an audio and video synchronization detection method based on an embodiment of the disclosure.

FIG. 5 is a schematic diagram of an audio and video synchronization detection device based on an embodiment of the disclosure.

FIG. 6 is a schematic diagram of an electronic equipment based on an embodiment of the disclosure.

FIG. 7 is a schematic diagram of a terminal based on an embodiment of the disclosure.

### DETAILED DESCRIPTION

Exemplary embodiments of the disclosure are described below with reference to the accompanying drawings, in which various details of the embodiments of the disclosure are included to facilitate understanding, and they should be considered as exemplary only. Therefore, those skilled in the art should realize that various changes and modifications can be made to the embodiments described herein without departing from the scope and spirit of the disclosure. For clarity and brief, descriptions of well-known functions and structures are omitted in the following description.

Image processing is a technology that uses computers to analyze images in order to achieve desired results. It is also known as picture processing. Image processing generally refers to digital image processing. A digital image is a large two-dimensional array obtained by photographing with industrial cameras, video cameras, scanners, etc. The elements of the array are called pixels and their values are called gray-scale values. Image processing technology typically includes three parts: image compression, enhancement and restoration, and matching, description and recognition.

Computer vision is a science that studies how to enable machines to “see”. More specifically, it involves using cameras and computers to replace the human eyes for tasks such as target identifying, tracking and measurement, and further process images to make them more suitable for human eyes observation or transmission to instruments for detection. As a scientific discipline, computer vision investigates related theories and technologies, aiming to establish an artificial intelligence system capable of obtaining “information” from images or multi-dimensional data. The term “information” here refers to Shannon-defined information that can be used to aid in making a “decision”. Since perception can be regarded as the extracting of information from sensory signals, computer vision can also be regarded as a science of enabling artificial systems to “perceive” from images or multi-dimensional data.

Artificial intelligence (AI) is a new technical science that studies and develops theories, methods, technologies and application systems for simulating, extending and expanding human intelligence.

In the embodiment of the present disclosure, a video reading tool can be used to read the video to be subjected to audio and video synchronization detection. Video reading tool decodes the video to obtain a video segment of a target length, and then performs audio and video synchronization detection on the video segment to acquire an audio and video synchronization detection result for the video segment.

Video decoding formats include but are not limited to: (1) H.264/AVC (Advanced Video Coding), with the video decoder being libx264; (2) H.265/HEVC (High Efficiency Video Coding), with the video decoder being libx265; (3) VP8 (Video Coding Format by Google), with the video decoder being libvpx; (4) VP9 (Successor to VP8), with the video decoder being libvpx-vp9; (5) AVI (AOMedia Video 1), with the video decoder being libaom-av1; (6) MPEG-2 (Moving Picture Experts Group Phase), with the video decoder being mpeg2video; (7) MPEG-4 (Moving Picture Experts Group Phase 4), with the video decoder being mpeg4; (8) Theora (Free and Open Video Codec), with the video decoder being libtheora; and ProRes (Apple ProRes), with the video decoder being prores; (10) DN×HD (Digital Nonlinear Extensible High Definition), with the video decoder being dnxhd; (11) WMV (Windows Media Video), with the video decoder being wmv2; (12) FLV1 (Flash Video), with the video decoder being flv; and (13) MJPEG (Motion JPEG), with the video decoder being mjpeg.

Audio decoding formats include but are not limited to: (1) AAC (Advanced Audio Coding), with the audio decoder being aac; (2) MP3 (MPEG-1 Audio Layer 3), with the audio decoder being libmp3lame; (3) Vorbis (Ogg Vorbis), with the audio decoder being libvorbis; (4) Opus (Audio Codec), with the audio decoder being libopus; (5) FLAC (Free Lossless Audio Codec), with the audio decoder being flac; (6) ALAC (Apple Lossless Audio Code), with the audio decoder being alac; (7) AC3 (Audio Codec 3), with the audio decoder being ac3; (8) WMA (Windows Media Audio), with the audio decoder being wmav2; (9) WAV (Waveform Audio File Format), with the audio decoder being built-in WAV decoder; (10) AMR (Adaptive Multi-Rate), with the audio decoders being libopencore_amrnb (NB) and libopencore_amrwb (WB); and (11) PCM (Pulse Code Modulation), with the audio decoders being pcm_s16le, pcm_s24le, etc.

During the video encoding and decoding process, the basic process is provided as follows. In the encoder, an image frame is divided into blocks, and intra prediction or inter prediction is performed on the current block to obtain a predict block for the current block. The original block of the current block is subtracted by the predict block to obtain a residual block, and the residual block is transformed and quantized to obtain a quantized coefficient matrix, which is subjected to entropy coding and output to a code stream. In the decoder, intra prediction or inter prediction is performed on the current block to obtain a predict block for the current block, on the other hand, a quantized coefficient matrix is obtained by decoding a code stream and then subjected to inverse quantization and inverse transform to obtain a residual block, and the predict block and the residual block are added to obtain a reconstruction block. The reconstruction blocks constitute a reconstruction image, and by performing in loop filter on the reconstruction image based on the image or block, a decoded image is obtained. The encoder also needs to perform similar operations as the decoder to obtain the decoded image. The decoded image can be used as a reference frame for subsequent inter prediction. Block division information, mode information such as prediction, transform, quantization, entropy coding, loop filtering, and parameter information determined by the encoder are output to the code stream if necessary. The decoder determines the same block division information, mode information such as prediction, transform, quantization, entropy coding and in loop filter or parameter information as the encoder by parsing and analyzing based on the existing information, so as to ensure that the decoded image obtained by the encoder is the same as that obtained by the decoder. Usually, the decoded image obtained by the encoder is also called a reconstruction image. The current block can be divided into prediction units during prediction, and the current block can be divided into transform units during transformation, and the divisions of the prediction and transformation units may be different. The above is the basic process of the video encoder and decoder under the block-based hybrid coding framework. Some modules or steps of the framework or process may be optimized with the development of technology. The embodiments of the present disclosure are applicable to the basic process under the block-based hybrid coding framework, but are not limited to the framework or process.

Currently, universal video coding standards adopt a block-based hybrid coding framework. Each frame in the video image is divided into square LCUs of the same size (such as 128×128, 64×64, etc.), and each LCU can further be divided into rectangular CUs based on rules. Additionally, a CU may be divided into smaller PUs, TUs, etc. In detail, the coding framework may include prediction, transform, quantization, entropy coding, in loop filter and other steps. Prediction can be divided into intra prediction and inter prediction, and inter prediction includes motion estimation and motion compensation. Because there is a strong correlation between adjacent pixels within a frame of a video image, the use of intra prediction in the video coding technology can eliminate spatial redundancy between adjacent pixels. However, since there is also strong similarity between adjacent frames in the video image, the use of inter prediction in the video coding technology can eliminate temporal redundancy between adjacent frames, thereby improving the efficiency of encoding and decoding.

A video is composed of multiple images. In order to make the video appear smooth, each second of video contains dozens or even hundreds of frames, such as 24 frames per second, 30 frames per second, 50 frames per second, 60 frames per second or 120 frames per second. As a result, there is significant temporal redundancy in the video, or in other word, there is a high degree of temporal correlation. Inter prediction leverages the time correlation to improve compression efficiency. Inter prediction often uses “motion” to exploit time correlation. A very simple “motion” model is that an object is located at a certain position in the image at a given moment, and after a certain period of time, it has moved to another position in the image at the current moment. This is the basic and commonly used translation motion in video coding. Inter prediction uses motion information to represent “motion”. Basic motion information includes the information of reference frame and motion vector (MV). The reference frame can also be understood as a reference picture. The encoder/decoder determines the reference frame/reference picture based on the information of the reference frame/reference picture, and determines the coordinates of the reference block based on the MV information and the coordinates of the current block. The coordinates of the reference block are used in the reference image to locate the reference block. Using the determined reference block as the prediction block is the most fundamental prediction method in inter prediction.

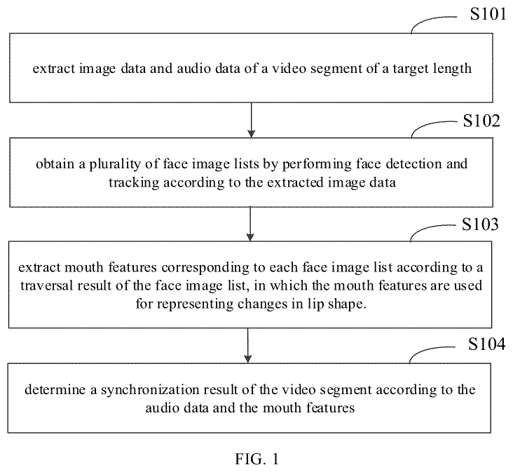

FIG. 1 is a flowchart of an audio and video synchronization detection method based on an embodiment of the disclosure. As illustrated in FIG. 1, the method includes the following steps.

At step S101, image data and audio data of a video segment of a target length are extracted.

It should be noted that the execution entity of the audio and video synchronization detection method in the embodiment of the present disclosure may be a hardware device with data audio and video synchronization detection capability and/or necessary software required to drive the hardware device to operate. Optionally, the execution entity may include workstations, servers, computers, user terminals and other smart devices. The user terminal include but are not limited to mobile phones, computers, smart voice interaction devices, smart home appliances, vehicle-mounted terminals, etc.

The video segment can be any video segment that needs to be subjected to audio and video synchronization detection after decoding.

The video segment usually includes image data and audio data, and the image data and audio data are aligned on the time axis.

It should be noted that the specific method for extracting image data and audio data of a video segment of a target length is not limited in the present disclosure, and can be selected based on the actual situation.

Optionally, audio frames in the video segment of the target length are extracted, and an audio data list is generated based on the audio frames, image frames in the video segment of the target length are extracted, and an image data list is generated based on the image frames.

Optionally, in a case that a preset interval is obtained, image frames {L₁ [symbol] L₂ [symbol] . . . Lₙ} within the video segment of the target length are extracted from the video segment based on the interval, and an image data list {L} is generated based on the image frames {L₁ [symbol] L₂ [symbol] . . . Lₙ}. Audio frames {A₁ [symbol] A₂ [symbol] . . . Aₙ} in the video segment of the target length are extracted from the video segment based on the interval, and an audio data list {A} is generated based on the audio frames.

For example, image frames in the video segment of the target length can be extracted from the video segment at an interval by using an image frame extraction tool, and audio frames in the video segment of the target length can be extracted from the video segment at an interval by using an audio extraction tool.

At step S102, a plurality of face image lists are obtained by performing face detection and tracking based on the extracted image data.

In the embodiment of the disclosure, the image frames in the image data list can be detected to obtain one or more face images each with a face area greater than a preset threshold. Each face image in the image frames is tracked based on facial features, and one or more face identifiers are obtained. One or more face lists are generated based on the face images and one or more face identifiers.

It should be noted that in order to improve the efficiency of audio and video synchronization detection, face areas in the image frame can be obtained, and the face with an area less than or equal to a set value (face area threshold) can be filtered out to obtain the final face images.

Optionally, after obtaining the final face images, each face image in the image frame can be tracked based on the face features, and one or more face IDs can be obtained.

In the embodiment of the disclosure, after obtaining the face IDs, the face IDs are denoted in the image frame, and one or more face image lists {F₁ [symbol] F₂ [symbol] . . . Fᵢ} are generated based on the face images and the face IDs.

The number of face image lists is the number of face IDs.

For example, for face ID1, the image frames containing the face ID1 are selected from the image frames and constitute a group to obtain an face image list F₁. For face ID2, the image frames containing the face ID2 are selected from the image frames and constitute a group to obtain an face image list F₂.

At step S103, mouth features corresponding to each face image list are extracted based on a traversal result of the face image list, in which the mouth features are used to characterize changes in lip movements.

In the embodiment of the disclosure, the face images in each face list are traversed, and the mouth features of each face image are extracted, and the mouth feature list of each face image can be generated based on the mouth features.

It should be noted that the specific method of extracting the mouth features of each face image is not limited in this disclosure, and can be selected based on the actual situation.

Optionally, the image frames in the face image list are input into a pre-trained facial feature extraction model to extract features of the image frames, and the mouth features corresponding to each face image list are extracted.

Through the above process, a mouth feature list of each face image can be generated.

At step S104, a synchronization result of the video segment is determined based on the audio data and the mouth features.

In the embodiment of the present disclosure, a labial-sound similarity corresponding to the face image list can be obtained based on the mouth feature list (which includes mouth feature corresponding to an opening and closing change) and an audio feature sequence of the audio data list. The audio and video synchronization detection is performed on the video segment based on the labial-sound similarity corresponding to the face image list, to determine the synchronization result of the video segment.

Optionally, a similarity threshold can be preset, and the statistical count of face image lists each with labial-sound similarity greater than or equal to the present similarity threshold can be obtained. The audio and video synchronization detection can be performed on the video based on the statistical count.

For example, a quantity threshold can be preset, and in response to the statistical count being greater than or equal to the quantity threshold, the video segment is determined to be audio-video synchronized. In response to the statistical count being less than the quantity threshold, the video segment is determined to be audio-video unsynchronized.

The audio and video synchronization detection method provided by the present disclosure extracts image data and audio data of a video segment of a target length, obtains a plurality of face image lists by performing face detection and tracking based on the extracted image data, and extracts extracting mouth features corresponding to each face image list based on a traversal result of the face image list, in which the mouth features are used to characterize changes in lip movements, and determine a synchronization result of the video segment based on the audio data and the mouth features. The present disclosure solves the issue of audio and video synchronization detection in scenarios involving many people by performing audio and video synchronization detection on the video segment based on the audio data and the mouth features, thus improving the accuracy and reliability of the audio and video synchronization detection result of the video segment.

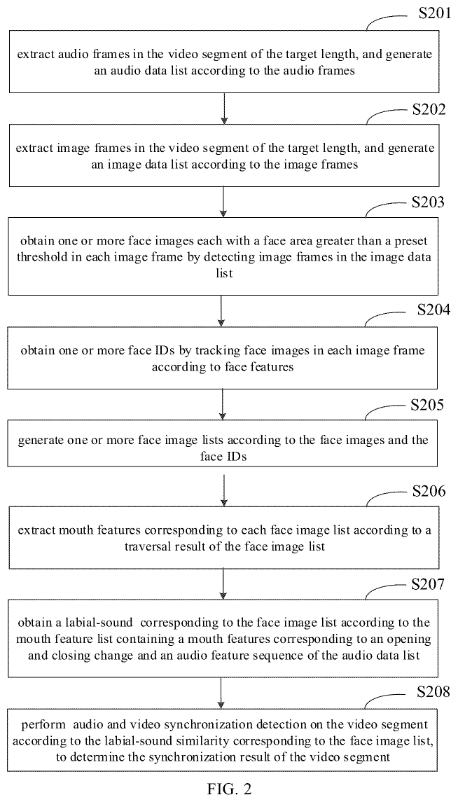

FIG. 2 is a flowchart of an audio and video synchronization detection method based on a second embodiment of the disclosure.

As illustrated in FIG. 2, on the basis of the embodiment of FIG. 2, the audio and video synchronization detection method of the embodiment of the disclosure includes the following steps.

A process of “image data and audio data of a video segment of a target length are extracted” in the step S101 of the above embodiment may specifically include the following steps S201 and S202.

At step S201, audio frames in the video segment of the target length are extracted, and an audio data list is generated based on the audio frames.

Optionally, an audio extraction tool extracts audio frames {A₁ [symbol] A₂ [symbol] . . . Aₙ} in the video segment of the target length. After obtaining the audio frames, the audio frames are stored in an audio data list {A} to generate an audio data list.

At step S202, image frames in the video segment of the target length are extracted, and an image data list is generated based on the image frames.

It should be noted that in order to ensure the synchronization of image frames and audio frames on the time axis, the image frames and the audio frames are extracted at the same interval.

Optionally, a video frame extraction tool extracts image frames {L₁ [symbol] L₂ [symbol] . . . Lₙ} in the video segment of the target length. After obtaining the video frames, the video frames can be stored in an image data list {L} to generate an image data list.

A process of “a plurality of face image lists are obtained by performing face detection and tracking based on the extracted image data” in the step S102 of the above embodiment may specifically include the following steps S203 and S205.

At step S203, one or more face images each with a face area greater than a preset threshold in each image frame are obtained by detecting the image frame in the image data list.

It should be noted that the specific method of detecting image frames in the image data list is not limited in this disclosure, and can be selected based on the actual situation.

Optionally, the image frames in the image data list are input into a pre-trained face detection model sequentially to detect faces in the image frames to obtain a face detection result, and one or more face images each with face area larger than a preset threshold can be obtained from the face detection result.

The preset threshold Sa is a face detection area threshold, which is not limited in the present disclosure and can be set based on the actual situation.

For example, for an image frame Aₜ₁, the image frame Aₜ₁ can be input into the pre-trained face detection model, so that the face detection model can perform face detection on the image frame Aₜ₁ to obtain the face detection result. From the face detection results, it is determined that the image frame Aₜ₁ contains a face 1 with a face detection area of S₁, a face 2 with a face detection area of S₂ and a face 3 with a face detection area of S₃, S₁<Sₐ [symbol] S₂>Sₐ [symbol] S₃>Sₐ, and thus the candidate faces in the image frame Aₜ₁ are face 2 and face 3.

At step S204, the face images in each image frame are tracked based on face features, and one or more face IDs are obtained.

In the embodiment of the disclosure, after obtaining one or more face images, face features are extracted from each face image to obtain the face features of the face image, and each face image in the image frame is tracked based on the face features, and one or more face IDs can be obtained.

Optionally, after obtaining the face IDs, the face IDs are denoted in the image frame.

For example, for image frame L₁, if the candidate faces of the image frame L₁ are face 2 and face 3, with face 2 having face identifier of ID2 and face 3 having face identifier of ID3, then ID2 and ID3 are marked in image frame L₁. For image frame L₂, the candidate faces of the image frame L₂ are face 3 and face 4, with face 3 having identifier of ID3 and a face 4 having face identifier of ID4, ID3 and ID4 are marked in image frame L₂.

At step S205, one or more face image lists are generated based on the face images and the face IDs.

In the embodiment of the disclosure, after obtaining the face IDs, the face images can be divided based on its face IDs to generate one or more face lists.

At step S206, mouth features corresponding to each face image list are extracted based on a traversal result of the face image list.

The related contents of step S206 can be referred to the above-mentioned embodiments, which will not be repeated here.

A process of “a synchronization result of the video segment is determined based on the audio data and the mouth features” in the step S104 of the above embodiment may specifically include the following steps S207 and S208.

At step S207, a labial-sound similarity corresponding to the image list is obtained based on the mouth feature list containing a mouth feature corresponding to an opening and closing change and an audio feature sequence of the audio data list.

Optionally, key points of a mouth can be extracted from a mouth feature image in the mouth feature list, and the key points of the mouth are tracked to obtain a motion trajectory, and then it is determined whether the mouth exhibits an opening and closing change based on the motion trajectory.

In the embodiment of the disclosure, lip movement features can be extracted from the mouth feature list to determine a mouth feature list that includes a mouth feature corresponding to the opening and closing change.

Optionally, the mouth feature list can be input into a pre-trained lip motion detection model to extract lip movement features to obtain the mouth feature list containing the mouth feature corresponding to the opening and closing change.

In the embodiment of the disclosure, the audio frames can be ranked based on the time stamps of the audio frames in the audio data list to obtain an audio frame sequence, and the audio features of the audio frame sequence are extracted to obtain an audio feature sequence.

For example, after obtaining the audio frames {A₁ [symbol] A₂ [symbol] . . . Aₙ}, the audio frames can be ranked based on the time stamps to obtain the audio frame sequence {Aₜ₁ [symbol] Aₜ₂ [symbol] . . . Aₜₙ}, and the audio features of the audio frame sequence are extracted to obtain the audio feature sequence {A′ₜ₁ [symbol] A′ₜ₂ . . . A′ₜₙ}.

In the embodiment of the disclosure, the mouth feature list containing the mouth feature corresponding to the opening and closing change and the audio feature sequence are input into the pre-trained labial-sound synchronization detection model. The labial-sound synchronization detection model performs cross-modal similarity calculation on the mouth feature list containing the mouth feature corresponding to the opening and closing change and the audio feature sequence, to obtain the labial-sound similarity corresponding to the face image list.

At step S208, audio and video synchronization detection is performed on the video segment based on the labial-sound similarity corresponding to the image list to determine the synchronization result of the video segment.

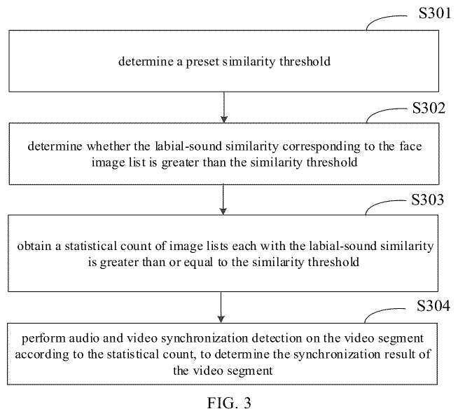

As illustrated in FIG. 3, a process of “audio and video synchronization detection is performed on the video segment based on the labial-sound similarity corresponding to the image list to determine the synchronization result of the video segment” in the step S208 of the above-mentioned embodiment specifically includes the following steps S301 and S304.

At step S301, a preset similarity threshold is determined.

It should be noted that the setting of the similarity threshold is not limited in this disclosure, and can be set based on the actual situation.

At step S302, it is determined whether the labial-sound similarity corresponding to the image list is greater than the similarity threshold.

At step S303, a statistical count of face image lists each with labial-sound similarity greater than or equal to the similarity threshold is obtained.

In the embodiment of the disclosure, after obtaining the labial-sound similarity corresponding to the face image list and the preset similarity threshold, it can be determined whether the labial-sound similarity corresponding to the face image list is greater than the similarity threshold, and based on the result, the statistical count of image lists each with labial-sound similarity greater than or equal to the similarity threshold is obtained.

At step S304, audio and video synchronization detection is performed on the video segment based on the statistical count, to determine the synchronization result of the video segment.

In the embodiment of the disclosure, a preset quantity threshold is determined, and audio and video synchronization detection is performed based on the statistical count and the preset quantity threshold.

It should be noted that the setting of the preset quantity threshold N is not limited in the disclosure. For example, the preset quantity threshold N may be 1.

Optionally, in response to the statistical count being greater than or equal to the quantity threshold, it is determined that audio and video in the video segment are synchronized.

For example, if the statistical count n is 2 and the preset quantity threshold N is 1, that is, the statistical count is greater than the quantity threshold, the video is determined to be audio-video synchronized.

Optionally, in response to the statistical count being less than the quantity threshold, the video is determined to be audio-video unsynchronized.

For example, if the statistical count n is 0 and the preset quantity threshold N is 1, that is, the statistical count is less than the quantity threshold, the video is determined to be audio-video unsynchronized.

In conclusion, based on the audio and video synchronization detection method proposed in the disclosure, the audio frames in the video segment of the target length are extracted, and the audio data list is generated based on the audio frames. The image frames in the image data list are detected to obtain one or more face images each with a face area larger than a preset threshold, the face images in each image frame are tracked based on the face features, and one or more face IDs are obtained. One or more face lists are generated based on the face images and the face IDs. The labial-sound similarity corresponding to the face image list is obtained based on the mouth feature list containing the mouth feature corresponding to the opening and closing change and the audio feature sequence of the audio data list. Audio and video synchronization detection is performed on the video segment based on the labial-sound similarity corresponding to the face image list, to determine the synchronization result of the video segment. Therefore, the disclosure generates one or more individual face lists based on the face images and the face IDs, which solves the issue of unsynchronized audio and video detection in the scenario involving many people. By performing audio and video synchronization detection based on the labial-sound similarity corresponding to the image list, the problem of detection omissions in the process of audio and video synchronization detection can be solved, which improves the accuracy and reliability of the audio and video synchronization detection result of the video, thereby improving the user experience when watching the video.

The specific process of the audio and video synchronization detection method proposed by the embodiment of the disclosure will be explained below.

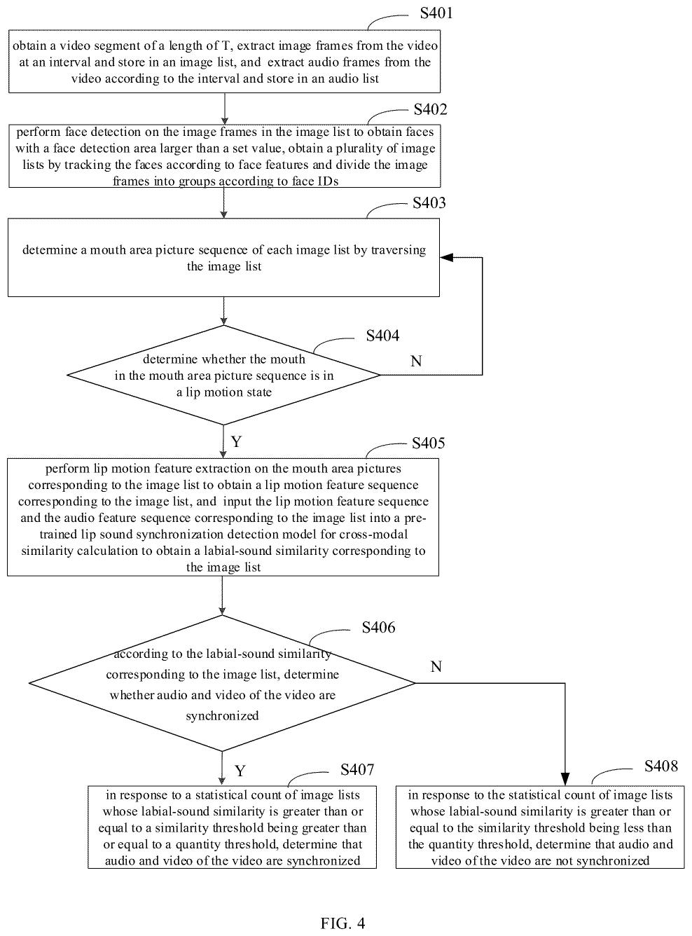

For example, as illustrated in FIG. 4, the specific process of the audio and video synchronization detection method may include the following steps.

At step S401, a video segment of a length of T is obtained, image frames are extracted from the video at an interval and stored in an image list, and audio frames are extracted from the video based on the interval and stored in an audio list.

At step S402, face detection is performed on the image frames in the image list to obtain faces with face detection areas larger than a set value, a plurality of image lists are obtained by tracking the faces based on face features and dividing the image frames into groups based on face IDs.

At step S403, a mouth area picture sequence of each image list is determined by traversing the image list.

At step S404, it is determined whether the mouth is in a lip-moving state.

It should be noted that key points of the mouth can be extracted from the mouth area pictures in the mouth area picture sequence. And the key points of the mouth can be tracked to obtain their motion trajectories. The mouth can be determined to be in a lip-moving state if the motion trajectories indicate opening and closing movements of the mouth.

It should be noted that by determining whether the mouth exhibits opening and closing movements, that is, whether the person is speaking, and determining that the mouth is in a lip-moving state before proceeding with subsequent steps, the method is suitable for audio and video synchronization detection for the scenario involving multi-person.

If it is determined that the mouth exhibits opening and closing movements, meaning the mouth is in a lip-moving state, then proceed to step S405.

If it is determined that the mouth does not exhibit opening and closing movements, meaning the mouth is not in a lip-moving state, then proceed to step S403.

At step S405, lip motion feature extraction is performed on the mouth area pictures corresponding to the image list to obtain a lip motion feature sequence corresponding to the image list, and the lip motion feature sequence and the audio feature sequence corresponding to the image list are input into a pre-trained labial-sound synchronization detection model for cross-modal similarity calculation to obtain a labial-sound similarity corresponding to the image list.

It should be noted that the labial-sound synchronization detection model is used to calculate a cross-modal similarity between the lip motion feature sequence and the audio feature sequence, and the audio and video synchronization detection is realized based on the labial-sound similarity, which improves the accuracy of the audio and video synchronization detection result.

At step S406, based on the labial-sound similarity corresponding to the image list, audio and video synchronization detection is performed on the video to determine whether audio and video of the video are synchronized.

At step S407, in response to a statistical count of image lists whose labial-sound similarity is greater than or equal to a similarity threshold being greater than or equal to a quantity threshold, the video is determined to be audio-video unsynchronized.

At step S408, in response to the statistical count of image lists whose labial-sound similarity is greater than or equal to the similarity threshold being less than the quantity threshold, the video is determined to be audio-video unsynchronized.

In conclusion, the audio and video synchronization detection method proposed in this disclosure groups the image frames through the face IDs and obtains the plurality of image lists, which solves the problem of unsynchronized audio and video in the scenario involving multi person. Based on the labial-sound similarity corresponding to the image list, audio and video synchronization detection is performed for the video, which avoids the problem of detection omissions in the process of audio and video synchronization detection, prevents the problem of secondary detection caused by detection omissions in the audio and video synchronization detection process, reduces the cost in the audio and video synchronization detection process, and improves the efficiency of audio and video synchronization detection, while ensuring the accuracy and reliability of the audio and video synchronization detection result of the video, thereby improving the user experience when watching the video.

In the technical scheme of this disclosure, the collection, storage, use, processing, transmission, provision and disclosure of personal information of users all comply with the provisions of relevant laws and regulations, and do not violate public order and good customs.

Based on the embodiment of the disclosure, the disclosure also provides an audio and video synchronization detection device for realizing the audio and video synchronization detection method.

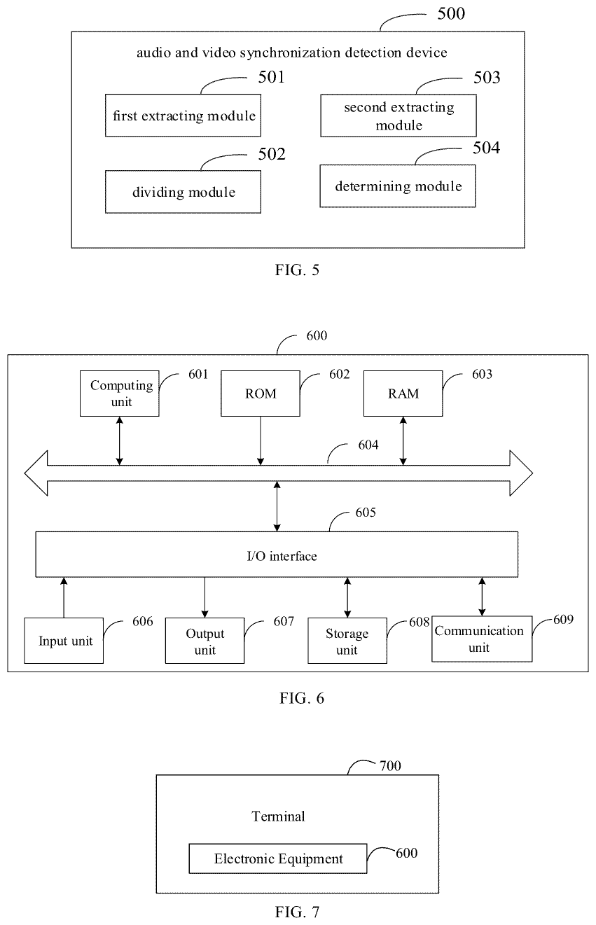

FIG. 5 is a schematic diagram of an audio and video synchronization detection device based on an embodiment of the disclosure.

As illustrated in FIG. 5, the audio and video synchronization detection device 500 includes:
a first extracting module 501, configured to extract image data and audio data of a video segment of a target length;
a dividing module 502, configured to obtain a plurality of face image lists by performing face detection and tracking based on the extracted image data;
a second extracting module 503, configured to extract mouth features corresponding to each face image list based on a traversal result of the face image list, in which the mouth features are used to characterize changes of lips; and a determining module 504, configured to determine a synchronization result of the video segment based on the audio data and the mouth features.

In an embodiment of the disclosure, the first extracting module 501 is configured to: extract audio frames in the video segment of the target length, and generate an audio data list based on the audio frames; and extract image frames in the video segment of the target length, and generate an image data list based on the image frames.

In an embodiment of the disclosure, the dividing module 502 is configured to: obtain one or more face images with face areas greater than a preset threshold in each image frame by detecting image frames in the image data list; track face images in each image frame based on face features and obtain one or more face IDs; generate one or more individual face lists based on the face images and the face IDs.

In an embodiment of the disclosure, the second extracting module 503 is configured to: traverse face images in each face list and extracting mouth features of each face image; and generate a mouth feature list of each face image based on the mouth features.

In an embodiment of the disclosure, the determining module 504 is configured to: obtain a labial-sound similarity corresponding to the image list based on the mouth feature list with mouth features having opening and closing changes and an audio feature sequence of the audio data list; and perform audio and video synchronization detection on the video segment based on the lip-sound similarity corresponding to the image list, to determine the synchronization result of the video segment.

In an embodiment of the disclosure, the process of determining the mouth feature list with mouth features having opening and closing changes, includes: determining the mouth feature list with mouth features having opening and closing changes by extracting lip motion features from the mouth feature list.

In an embodiment of the disclosure, the process of determining the audio feature sequence, includes: obtaining an audio frame sequence by ranking the audio frames based on time stamps of the audio frames in the audio data list; and obtaining the audio feature sequence by extracting audio features from the audio frame sequence.

In an embodiment of the disclosure, the determining module 504 is configured to: input the mouth feature list with mouth features having opening and closing changes and the audio feature sequence into a pre-trained labial-sound synchronization detection model; and obtain the labial-sound similarity corresponding to the image list by performing cross-modal similarity calculation on the mouth feature list with mouth features having opening and closing changes and the audio feature sequence through the labial-sound synchronization detection model.

In an embodiment of the disclosure, the determining module 504 is configured to: determine a preset similarity threshold; determine whether the labial-sound similarity corresponding to the image list is greater than the similarity threshold; obtain a statistical count of image lists whose labial-sound similarity is greater than or equal to the similarity threshold; and perform audio and video synchronization detection on the video segment based on the statistical count, to determine the synchronization result of the video segment.

The audio and video synchronization detection device provided by the present disclosure extracts image data and audio data of a video segment of a target length, obtains a plurality of face image lists by performing face detection and tracking based on the extracted image data, and extracts extracting mouth features corresponding to each face image list based on a traversal result of the face image list, in which the mouth features are used to characterize changes in lip movements, and determine a synchronization result of the video segment based on the audio data and the mouth features. The disclosure solves the problem of audio and video synchronization detection in scenarios involving many people by performing audio and video synchronization detection on the video segment through the audio data and the mouth features, thus improving the accuracy and reliability of the audio and video synchronization detection result of the video segment.

Based on the embodiments of the disclosure, the disclosure also provides an electronic equipment, a terminal and a computer program product.

FIG. 6 is a block diagram of an exemplary electronic equipment 600 used to implement the embodiment of the disclosure. The device is intended to represent various forms of digital computers, such as laptop computers, desktop computers, workbenches, personal digital assistants, servers, blade servers, mainframe computers, and other suitable computers. The device may also represent various forms of mobile devices, such as personal digital processors, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the equipment 600 includes a computing unit 601 for performing various appropriate actions and processes based on computer programs stored in a Read-Only Memory (ROM) 602 or computer programs loaded from a storage unit 608 to a Random Access Memory (RAM) 603. In the RAM 603, various programs and data required for the operation of the equipment 600 are stored. The computing unit 601, the ROM 602, and the RAM 603 are connected to each other through a bus 604. An input/output (I/O) interface 605 is also connected to the bus 604.

Components in the equipment 600 are connected to the I/O interface 605, including: an input unit 606, such as a keyboard, a mouse; an output unit 607, such as various types of displays, speakers; a storage unit 608, such as a disk, an optical disk; and a communication unit 609, such as network cards, modems, and wireless communication transceivers. The communication unit 609 allows the equipment 600 to exchange information/data with other devices through a computer network such as the Internet and/or various telecommunication networks.

The computing unit 601 may be various general-purpose and/or dedicated processing components with processing and computing capabilities. Some examples of the computing unit 601 include, but are not limited to, a Central Processing Unit (CPU), a Graphics Processing Unit (GPU), various dedicated AI computing chips, various computing units that run machine learning (ML) model algorithms, a Digital Signal Processor (DSP), and any appropriate processor, controller and microcontroller. The computing unit 601 executes the various methods and processes described above, such as the audio and video synchronization detection method. For example, in some embodiments, the above method may be implemented as a computer software program, which is tangibly contained in a machine-readable medium, such as the storage unit 608. In some embodiments, part or all of the computer programs may be loaded and/or installed on the electronic equipment 600 via the ROM 602 and/or the communication unit 609. When the computer program is loaded on the RAM 603 and executed by the computing unit 601, one or more steps of each of the above method may be executed. Alternatively, in other embodiments, the computing unit 601 may be configured to perform the above method in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting the data and instructions to the storage system, the at least one input device and the at least one output device.

The program code configured to implement the method of the disclosure may be written in any combination of one or more programming languages. These program code may be provided to the processor or controller of a general-purpose computer, a dedicated computer, or other programmable data processing devices, so that when the program code is executed by the processor or controller, the functions/operations specified in the flowchart and/or block diagram can be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, a device, or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium include electrical connections based on one or more wires, portable computer disks, hard disks, RAMs, ROMs, Electrically Programmable Read-Only-Memories (EPROMs), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such back-end components, middleware components, and front-end components. The components of the system may be interconnected by any form or medium of digital data communication (e.g., a communication network). The communication network may include, for example, Local Area Network (LAN), Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

Based on an embodiment of the disclosure, the disclosure also provides a terminal. As shown in FIG. 7, the terminal 700 includes the electronic equipment 600.

Based on the embodiment of the disclosure, the disclosure also provides a computer program product including a computer program. When the computer program is executed by a processor, the steps of the audio and video synchronization detection method described in the above embodiments of the disclosure are executed.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made based on design requirements and other factors. Any modification, equivalent replacement and improvement made within the spirit and principle of this application shall be included in the protection scope of this application.

1. An audio and video synchronization detection method, comprising:
extracting image data and audio data of a video segment of a target length;
obtaining a plurality of face image lists by performing face detection and tracking based on the extracted image data;
extracting mouth features corresponding to each face image list based on a traversal result of the face image list, wherein the mouth features are used to characterize changes of lips; and
determining a synchronization result of the video segment based on the audio data and the mouth features.

2. The method of claim 1, wherein extracting the image data and the audio data of the video segment of the target length, comprises:
extracting audio frames in the video segment of the target length, and generating an audio data list based on the audio frames; and
extracting image frames in the video segment of the target length, and generating an image data list based on the image frames.

3. The method of claim 2, wherein obtaining the plurality of face image lists by performing face detection and tracking based on the extracted image data, comprises:
obtaining one or more face images each with a face area greater than a preset threshold in each image frame by detecting the image frame in the image data list;
obtaining one or more face identity documents (IDs) by tracking face images in each image frame based on face features, and
generating one or more face image lists based on the face images and the one or more face IDs.

4. The method of claim 3, wherein extracting the mouth features corresponding to each face image list based on the traversal result of the face image list, comprises:
traversing face images in each face image list and extracting mouth features of each face image; and
generating a mouth feature list of each face image based on the mouth features of each face image.

5. The method of claim 4, wherein determining the synchronization result of the video segment based on the audio data and the mouth features, comprises:
obtaining a labial-sound similarity corresponding to the face image list based on a mouth feature list containing a mouth feature corresponding to an opening and closing change and an audio feature sequence of the audio data list; and
performing audio and video synchronization detection on the video segment based on the labial-sound similarity corresponding to the image list, to determine the synchronization result of the video segment.

6. The method of claim 5, wherein a process of determining the mouth feature list containing the mouth feature corresponding to the opening and closing change, comprises:
determining the mouth feature list containing the mouth feature corresponding to the opening and closing change by extracting lip movement features from the mouth feature list.

7. The method of claim 5, wherein determining the audio feature sequence, comprises:
obtaining an audio frame sequence by ranking the audio frames based on time stamps of the audio frames in the audio data list; and
obtaining the audio feature sequence by extracting audio features from the audio frame sequence.

8. The method of claim 5, wherein obtaining the labial-sound similarity corresponding to the face image list based on the mouth feature list containing the mouth feature corresponding to the opening and closing change and the audio feature sequence of the audio data list, comprises:
inputting the mouth feature list containing the mouth feature corresponding to the opening and closing change and the audio feature sequence into a pre-trained labial-sound synchronization detection model; and
obtaining the labial-sound similarity corresponding to the face image list by performing cross-modal similarity calculation on the mouth feature list containing the mouth feature corresponding to the opening and closing change and the audio feature sequence through the labial-sound synchronization detection model.

9. The method of claim 5, wherein performing audio and video synchronization detection on the video segment based on the labial-sound similarity corresponding to the face image list, to determine the synchronization result of the video segment, comprises:
determining a preset similarity threshold;
determining whether the labial-sound similarity corresponding to the face image list is greater than the preset similarity threshold;
obtaining a statistical count of face image lists each with the labial-sound similarity greater than or equal to the preset similarity threshold; and
performing audio and video synchronization detection on the video segment based on the statistical count, to determine the synchronization result of the video segment.

10. The method of claim 6, wherein performing audio and video synchronization detection on the video segment based on the statistical count, to determine the synchronization result of the video segment, comprises:
determining a preset quantity threshold;
in response to the statistical count being greater than or equal to the preset quantity threshold, determining that the video segment is audio-video synchronized; and
in response to the statistical count being less than the preset quantity threshold, determining that the video segment is audio-video unsynchronized.

11. The method of claim 6, before determining the audio feature sequence, further comprising:
extracting key points of a mouth from a mouth feature image in the mouth feature list, and tracking the key points to obtain a motion trajectory of the key points; and
determining whether the mouth exhibits an opening and closing change based on the motion trajectory.

12. An electronic equipment, comprising a processor and a memory;
wherein the processor reads an executable program code stored in the memory and runs a program corresponding to the executable program code, to:
extract image data and audio data of a video segment of a target length;
obtain a plurality of face image lists by performing face detection and tracking based on the extracted image data;
extract mouth features corresponding to each face image list based on a traversal result of the face image list, wherein the mouth features are used to characterize changes of lips; and
determine a synchronization result of the video segment based on the audio data and the mouth features.

13. The device electronic equipment of claim 12, wherein extracting the image data and the audio data of the video segment of the target length comprises:
extracting audio frames in the video segment of the target length, and generating an audio data list based on the audio frames; and
extracting image frames in the video segment of the target length, and generating an image data list based on the image frames.

14. The electronic equipment of claim 13, wherein obtaining the plurality of face image lists by performing face detection and tracking based on the extracted image data comprises:
obtaining one or more face images each with a face area greater than a preset threshold in each image frame by detecting the image frame in the image data list;
obtaining one or more face identity documents (IDs) by tracking face images in each image frame based on face features, and
generating one or more face image lists based on the face images and the one or more face IDs.

15. The device electronic equipment of claim 14, wherein extracting the mouth features corresponding to each face image list based on the traversal result of the face image list comprises:
traversing face images in each face image list and extracting mouth features of each face image; and
generating a mouth feature list of each face image based on the mouth features of each face image.

16. The device electronic equipment of claim 15, wherein determining the synchronization result of the video segment based on the audio data and the mouth features comprises:
obtaining a labial-sound similarity corresponding to the face image list based on a mouth feature list containing a mouth feature corresponding to an opening and closing change and an audio feature sequence of the audio data list; and
performing audio and video synchronization detection on the video segment based on the labial-sound similarity corresponding to the image list, to determine the synchronization result of the video segment.

17. The electronic equipment of claim 16, wherein a process of determining the mouth feature list containing the mouth feature corresponding to the opening and closing change, comprises:
determining the mouth feature list containing the mouth feature corresponding to the opening and closing change by extracting lip movement features from the mouth feature list.

18. The electronic equipment of claim 16, wherein determining the audio feature sequence comprises:
obtaining an audio frame sequence by ranking the audio frames based on time stamps of the audio frames in the audio data list; and
obtaining the audio feature sequence by extracting audio features from the audio frame sequence.

19. (canceled)

20. (canceled)

21. (canceled)

22. A terminal, comprising the electronic equipment based on claim 12.

23. A computer program product comprising a computer program, wherein when the computer program is executed by a processor, the method for audio and video synchronization detection is implemented, comprising:
extracting image data and audio data of a video segment of a target length;
obtaining a plurality of face image lists by performing face detection and tracking based on the extracted image data;
extracting mouth features corresponding to each face image list based on a traversal result of the face image list, wherein the mouth features are used to characterize changes of lips; and
determining a synchronization result of the video segment based on the audio data and the mouth features.
